(19) United States
(12) Patent Application Publication
(10) Pub. No.: US 2023/0092698 A1
(43) Pub. Date: Mar. 23, 2023

(54) TWO-PART SILICONECOMPOSITION AND SEALANT AND ASSEMBLY MADE THEREFROM

(71) Applicant: 3M INNOVATIVE PROPERTIES COMPANY, St. Paul, MN (US)

(72) Inventors: Lianzhou Chen, Woodbury, MN (US); Enzhong Zhang, Shanghai (CN); Shaomin Sun, Shanghai (CN); Zhonghai Cai, Shanghai (CN); Shaoqing Gu, Shanghai (CN)

(21) Appl. No.: 17/789,476

(22) PCT Filed: Dec. 27, 2019
(86) PCT No.: PCT/CN2019/129161

§ 371 Date: Jun. 27, 2022

(51) Int. Cl. C08L 83/04; C09K 3/10; B32B 7/12; H01M 50/231; H01M 50/227; H01M 50/222; H01M 50/229; H01M 50/202

(52) U.S. Cl. CPC C08L 83/04; C09K 3/1018; B32B 7/12; H01M 50/231; H01M 50/227; H01M 50/222; H01M 50/229; H01M 50/202; C08L 2203/20; C08L 2205/18; C09K 2200/0685; C09K 2200/0239; C09K 2200/0208; B32B 2255/26; B32B 2307/748; B32B 2307/3065; B32B 2307/7265; B32B 2439/40

(57) ABSTRACT

The two-part composition includes a first part and a second part. The first part includes a vinyl-substituted polysiloxane, a hydrosilylation catalyst, expandable graphite comprising moisture, and first polymeric microspheres having been at least partially coated with inorganic filler. The second part includes a second vinyl-substituted polysiloxane, a hydrosilyl-substituted polysiloxane, and second polymeric microspheres having been at least partially coated with flame-retardant inorganic filler. The two-part composition is useful, for example, for curing into a sealant and making an assembly. The assembly has a first substrate and a second substrate with a cured product of the two-part composition in contact with the first substrate and the second substrate. Methods of making a sealant and an assembly are also described.

### BACKGROUND

Metal-curable silicone polymers can be used as a one-part silicone system or a two-part silicone system. One-part and two-part metal (platinum) curable silicone polymers are commercially available. In a two-part silicone system, also referred to as liquid silicone rubber (LSR), a vinyl-functional silicone polymer (typically identified as part A) may be vulcanized in presence of a silicone having Si—H groups (part B). Part A typically contains the platinum catalyst. Two-part platinum curable silicone systems are commercially available, for example, under the trade designation ELASTOSIL R 533/60 A/B and ELASTOSIL LR 7665 from Wacker Chemie, AG and SILASTIC 9252/900P from Dow Corning.

Cured products for use as sealers and gaskets in assemblies need to be able to effectively seal a junction between two substrates. Compression set measures the ability of a material to return to its original thickness after prolonged compressive stresses at a given temperature. As a material is compressed over time, it might lose its ability to return to its original thickness. This loss of resiliency may reduce the capability of an elastomeric gasket, seal, or cushioning pad to perform over a long period of time. Silicone foams prepared from a two-part composition that can be cured at room temperature and are reported to have a low compression set are reported in U.S. Pat. No. 6,022,904 (Sollradl et al.).

### SUMMARY OF THE DISCLOSURE

The present disclosure provides a two-part composition that includes a first part and a second part. The first part includes a vinyl-substituted polysiloxane, a hydrosilylation catalyst, expandable graphite comprising moisture, and first polymeric microspheres having been at least partially coated with inorganic filler. The second part includes a second vinyl-substituted polysiloxane, a hydrosilyl-substituted polysiloxane, and second polymeric microspheres having been at least partially coated with flame-retardant inorganic filler.

The present disclosure further provides a cured product of the two-part composition. The cured product can be a sealant. The cured product can be prepared by combining the first part and the second part and allowing the resulting curable composition cure at room temperature for up to 24 hours.

The present disclosure further provides an assembly. The assembly includes a first substrate and a second substrate. The assembly further includes a cured product of the two-part composition. The cured product of the two-part composition is in contact with the first substrate and the second substrate.

The present disclosure further provides a vehicle that includes the assembly.

The present disclosure further provides a method of making the assembly. The method includes combining the first part and the second part to form a curable composition, contacting a first substrate or a second substrate with the two-part composition, and allowing the curable composition to cure on the first substrate or the second substrate. The curable composition typically can be cured at room temperature for 24 hours.

The present disclosure further provides a method of making a curable composition. The method includes combining the first part and the second part to form the curable composition.

The present disclosure further provides a system for performing the method of making the curable composition. The system can include a first chamber and a second chamber, wherein the first chamber comprises the first part, and wherein the second chamber comprises the second part.

There are various advantages associated with the curable compositions, cured products, systems, assemblies, and methods disclosed herein, some of which are unexpected. In some embodiments, the cured product from the two-part composition can have a compression set that is low enough to allow the cured product to serve as an effective sealer or gasket. In some embodiments, the sealer or gasket can continue to be effective after undergoing multiple compression and decompression cycles which can allow for an assembly to be serviced by separating components in contact with the sealer or gasket. In some embodiments, the two-part composition has good storage stability, as evidenced by a relatively small change in compression set of the cured sealant after room temperature aging of the two-part composition. The storage stability is improved in comparison to a comparative composition in which the second part includes polymeric microspheres coated with calcium carbonate. In the comparative composition, there was a relatively large increase in compression set of the cured sealant after room temperature aging of the comparative two-part composition. In some embodiments, the two-part composition and cured product made therefrom has useful flame retardant properties.

### BRIEF DESCRIPTION OF THE FIGURES

The drawings illustrate generally, by way of example, but not by way of limitation, various embodiments discussed in the present disclosure.

FIG. 1A is a sectional view of an assembly in a resting state.

FIG. 1B is a sectional view of the assembly in a compressed state.

FIG. 1C is a top view of the assembly.

### DETAILED DESCRIPTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

The term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

In this application, terms such as “a,” “an,” and “the” are not intended to refer to only a singular entity but include the general class of which a specific example may be used for illustration. The terms “a,” “an,” and “the” are used interchangeably with the phrases “at least one” and “one or more.” The phrases “at least one of” and “comprises at least one of” followed by a list refers to any one of the items in the list and any combination of two or more items in the list.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-, 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

The term “room temperature” as used herein refers to a temperature of about 15° C. to 40° C.

The polymers described herein can terminate in any suitable way. In some embodiments, the polymers can terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

The two-part composition of the present disclosure includes a first part and a second part. The first part and the second part include a first vinyl-substituted polysiloxane and a second vinyl-substituted polysiloxane, respectively. The first vinyl-substituted polysiloxane and a second vinyl-substituted polysiloxane can be the same or different from each other, and each can include one or more vinyl polysiloxanes. In some embodiments, the first and second vinyl-substituted polysiloxanes are identical in structure, molecular weight, mole percent of repeating units, and vinyl content. In other embodiments, the first and/or second vinyl-substituted polysiloxane can include a blend of vinyl-substituted polysiloxanes that differ in structure, molecular weight, mole percent of repeating units, or vinyl content. In some embodiments the vinyl-substituted polysiloxane comprises one or more vinyl polysiloxane homopolymers, vinyl polysiloxane copolymers, or combinations thereof.

The vinyl-substituted polysiloxane can be present in the two-part composition (e.g., the first part, the second part, or the curable composition resulting from combining the first part and the second part) in any suitable weight percentage (wt %). For example, the vinyl-substituted polysiloxane can be present in a range of from about 20 wt % to about 90 wt %, about 29 wt % to about 80 wt %, about 34 wt % to about 46 wt %, or less than, equal to, or greater than about 20 wt %, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, or about 90 wt %, based on the total weight of the two-part composition (e.g., the first part, the second part, both the first part and the second part, or the curable composition resulting from combining the first part and the second part).

In some embodiments, the vinyl-substituted polysiloxane in the two-part composition comprises first divalent units independently represented by formula X:

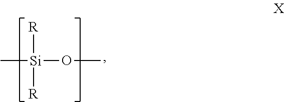

wherein each R is independently —H, —OH, or a substituted or unsubstituted C₁₋₂₀ hydrocarbyl group. In some embodiments, each R is independently a substituted or unsubstituted C₁₋₂₀ hydrocarbyl group. Suitable hydrocarbyl groups include alkyl, alkenyl, alkynyl, cycloalkyl, alkoxy, aryl, arylalkylenyl, or heterocycloalkylenyl, wherein alkyl and arylalkylenyl are unsubstituted or substituted with halogen and optionally interrupted by at least one catenated —O—, —S—, —N(R′)—, or combination thereof (in some embodiments, —O—, —S—, and combinations thereof, or —O—), wherein aryl, arylalkylenyl, and heterocycloalkyenyl are unsubstituted or substituted by at least one alkyl, alkoxy, halogen, or combination thereof. R′ is hydrogen, alkyl, aryl, or arylalkylenyl, wherein aryl and arylalkylenyl are unsubstituted or substituted by at least one alkyl, alkoxy, or combination thereof. In some embodiments, R′ is hydrogen or alkyl, for example, having 1 to 4 carbon atoms (e.g., methyl, ethyl, n-propyl, isopropyl, n-butyl, isobutyl, or sec-butyl). In some embodiments, R′ is methyl or hydrogen. In some embodiments, the halogen or halogens on the alkyl, aryl, arylalkylenyl, or heterocycloalkylenyl groups is fluoro. When R is fluorinated, fluorinated and perfluorinated groups such as F[CF(CF₃)CF₂O]ₐCF(CF₃)CⱼH2ⱼ- (wherein j is an integer of 2 to 8 (or 2 to 3) and a has an average value of 4 to 20), C₄F₉C₃H₆—, C₄F₉C₂H₄—, C₄F₉OC₃H₆—, C₆F₁₃C₃H₆—, CF₃C₃H₆—, and CF₃C₂H₄— can be useful. In some embodiments, the alkyl group is perfluorinated. In some embodiments, each R is independently alkyl, aryl, or alkyl substituted by fluoro and optionally interrupted by at least one catenated —O— group. Suitable alkyl groups for R in formula X typically have 1 to 10, 1 to 6, or 1 to 4 carbon atoms. Examples of useful alkyl groups include methyl, ethyl, isopropyl, n-propyl, n-butyl, and iso-butyl. In some embodiments, each R is independently alkyl having up to six (in some embodiments, up to 4, 3, or 2) carbon atoms, phenyl, benzyl, or C₆H₅C₂H₄—. In some embodiments, each R is independently methyl or phenyl. In some embodiments, each R is methyl.

In some embodiments, the vinyl-substituted polysiloxane in the two-part composition comprises at least one of a terminal unit represented by formula -Q-CH═CH₂ or a second divalent unit represented by formula XI

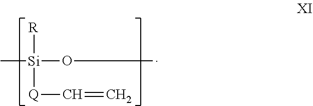

In some embodiments, the vinyl-substituted polysiloxane includes the divalent units represented by formula XI. In formula XI, each R is as defined above for a divalent unit of formula X, and each Q is independently a bond, alkylene, arylene, or alkylene that is at least one of interrupted or terminated by aryl, wherein the alkylene, arylene, and alkylene that is at least one of interrupted or terminated by aryl are optionally at least one of interrupted or terminated by at least one ether (i.e., —O—), thioether (i.e., —S—), amine (i.e., —NR′—), amide (i.e., —N(R′)—C(O)— or —C(O)—N(R′)—), ester (i.e., —O—C(O)— or —C(O)—O—), thioester (i.e., —S—C(O)— or —C(O)—S—), carbonate (i.e., —O—C(O)—O—), thiocarbonate (i.e., —S—C(O)—O— or —O—C(O)—S—), carbamate (i.e., —(R′)N—C(O)—O— or —O—C(O)—N(R′)—, thiocarbamate (i.e., —N(R′)—C(O)—S— or —S—C(O)—N(R′)—, urea (i.e., —(R′)N—C(O)—N(R′)—), thiourea (i.e., —(R′)N—C(S)—N(R′)). In any of these groups that include an R′, R′ is hydrogen, alkyl, aryl, or arylalkylenyl, wherein aryl and arylalkylenyl are unsubstituted or substituted by at least one alkyl, alkoxy, or combination thereof. In some embodiments, R′ is hydrogen or alkyl, for example, having 1 to 4 carbon atoms (e.g., methyl, ethyl, n-propyl, isopropyl, n-butyl, isobutyl, or sec-butyl). In some embodiments, R′ is methyl or hydrogen. The phrase “interrupted by at least one functional group” refers to having part of the alkylene, arylalkylene, or alkylarylene group on either side of the functional group. An example of an alkylene interrupted by an ether is —CH₂—CH₂—O—CH₂—CH₂—. Similarly, an alkylene that is interrupted by arylene has part of the alkylene on either side of the arylene (e.g., —CH₂—CH₂—C₆H₄—CH₂—).

In some embodiments, each Q is independently alkylene that is optionally at least one of interrupted or terminated by at least one ether, thioether, or combination thereof. The alkylene can have 1 to 10, 1 to 6, or 1 to 4 carbon atoms. In some embodiments, Q is alkylene having 1 to 10, 1 to 6, or 1 to 4 carbon atoms. In some embodiments, Q is a poly(alkylene oxide) group. Suitable poly(alkylene oxide) groups include those represented by formula (OR″)_{a′}, in which each OR″ is independently —CH₂CH₂O—, —CH(CH₃)CH₂O—, —CH₂CH₂CH₂O—, —CH₂CH(CH₃)O—, —CH₂CH₂CH₂CH₂O—, —CH(CH₂CH₃)CH₂O—, —CH₂CH(CH₂CH₃)O—, and —CH₂C(CH₃)₂O—. In some embodiments, each OR″ independently represents —CH₂CH₂O—, —CH(CH₃)CH₂O— or —CH₂CH(CH₃)O—. Each a′ is independently a value from 5 to 300 (in some embodiments, from 10 to about 250, or from 20 to about 200). In some embodiments, Q is a bond.

In some embodiments, the vinyl-substituted polysiloxane in the two-part composition comprises a terminal unit represented by formula -Q-CH═CH₂. In some embodiments, the vinyl-substituted polysiloxane includes one terminal unit represented by formula -Q-CH═CH₂. In some embodiments, the vinyl-substituted polysiloxane includes two terminal units represented by formula -Q-CH═CH₂. If the vinyl-substituted polysiloxane is branched, it can include more than two terminal units represented by formula -Q-CH═CH₂. In formula -Q-CH═CH₂, each Q is as defined above in any of the definitions described for formula XI. In some embodiments, Q is a bond.

The vinyl-substituted polysiloxanes can be prepared by known synthetic methods, and many are commercially available (for example, from Wacker Chemie AG, Munich, Germany, Shin-Etsu Chemical, Tokyo, Japan, Dow Corning Corporation, or from Gelest, Inc. (see, for example, the polysiloxanes described in Silicon Compounds: Silanes and Silicones, Second Edition, edited by B. Arkles and G. Larson, Gelest, Inc. (2008)). Fluorinated polysiloxanes can be prepared by using known synthetic methods including the platinum-catalyzed addition reaction of a fluorinated olefin and a hydrosiloxane (small molecule, oligomer, or polymer). In some embodiments, the vinyl-substituted polysiloxane comprises a vinyl-substituted polysiloxane represented by Formula I:

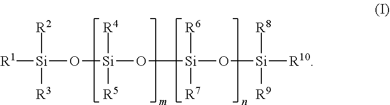

In Formula I, R¹, R², R³, R⁴, R⁵, R⁶, R⁷, R⁸, R⁹, and R¹⁰, are independently —H, —OH, or substituted or ⁹ unsubstituted (C₁-C₂₀)hydrocarbyl as described above for R in any of its embodiments. At least one of R¹, R⁴, R⁵, or R¹⁰ comprises a vinyl group. Additionally, m and n are in random or block orientation. In some embodiments, R¹, R², R³, R⁴, R⁵, R⁶, R⁷, R⁸, R⁹, and R¹⁰ of the polysiloxane according to Formula I are independently substituted or unsubstituted (C₁-C₂₀)alkyl, (C₁-C₂₀)alkenyl, (C₁-C₂₀)alkynyl, (C₁-C₂₀)cycloalkyl, (C₁-C₂₀)aryl, (C₁-C₂₀)alkoxyl, or (C₁-C₂₀)haloalkyl, wherein at least one of R¹, R⁴, R⁵, or R¹⁰ comprises a vinyl group. In some embodiments, R¹, R², R³, R⁴, R⁵, R⁶, R⁷, R⁸, R⁹, and R¹⁰ of the polysiloxane according to Formula I are independently substituted or unsubstituted (C₁-C₂₀)alkyl, (C₁-C₂₀)cycloalkyl, (C₁-C₂₀)aryl, or (C₁-C₂₀)haloalkyl, wherein at least one of R¹, R⁴, R⁵, or R¹⁰ comprises a vinyl group.

In formula I, the units m and n can represent the number of each repeating unit in the polysiloxane. Alternatively or additionally, the units m and n can represent the mol % of each repeating unit in the polysiloxane. The unit m can be any positive integer and the unit n can be any positive integer or zero. In some embodiments, and m +n is in a range from 10 to 500, 10 to 400, 10 to 300, 12 to 300, 13 to 300, 13 to 200, 10 to 100, 10 to 50, or 10 to 30. In some embodiments, n is 0, and m is in a range from 20 to 200, 30 to 100, or 10 to 100. In some embodiments, m is 0, and n is in a range from 20 to 200, 30 to 100, or 10 to 100. In some embodiments when m is 0, at least one of R¹ or R¹⁰ comprises a vinyl group. In some embodiments of Formula I, at least 40 percent, and in some embodiments at least 50 percent, of the R¹, R², R³, R⁴, R⁵, R⁶, R⁷, R⁸, R⁹, and R¹⁰ groups are phenyl, methyl, or combinations thereof. For example, at least 60 percent, at least 70 percent, at least 80 percent, at least 90 percent, at least 95 percent, at least 98 percent, or at least 99 percent of the R¹, R², R³, R⁴, R⁵, R⁶, R⁷, R⁸, R⁹, and R¹⁰ groups can be phenyl, methyl, or combinations thereof. In some embodiments of Formula I, at least 40 percent, and in some embodiments at least 50 percent, of the R¹, R², R³, R⁴, R⁵, R⁶, R⁷, R⁸, R⁹, and R¹⁰ groups are methyl. For example, at least 60 percent, at least 70 percent, at least 80 percent, at least 90 percent, at least 95 percent, at least 98 percent, or at least 99 percent of the R¹, R², R³, R⁴, R⁵, R⁶, R⁷, R⁸, R⁹, and R¹⁰ groups can be methyl. In some embodiments, each R¹, R², R³, R⁴, R⁵, R⁶, R⁷, R⁸, R⁹, and R¹⁰ is methyl. Although Formula I is shown as a block copolymer, it should be understood that the divalent units of formulas X and XI can be randomly positioned in the copolymer. Thus, polyorganosiloxanes useful for practicing the present disclosure also include random copolymers.

In some embodiments, the vinyl-substituted polysiloxane comprises a vinyl-substituted polysiloxane represented by at least one of Formula II or Formula III:

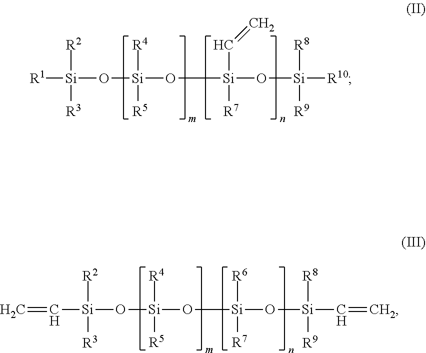

wherein R¹, R², R³, R⁴, R⁵, R⁶, R⁷, R⁸, R⁹, R¹⁰, m, and n are as defined above in any of their embodiments.

In some embodiments, the vinyl-substituted polysiloxane comprises a vinyl-substituted polysiloxane represented by Formula IV:

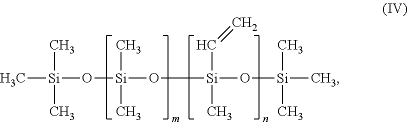

wherein m and n are as defined above in any of their embodiments.

In some embodiments, the vinyl-substituted polysiloxane comprises a vinyl-substituted polysiloxane represented by Formula V:

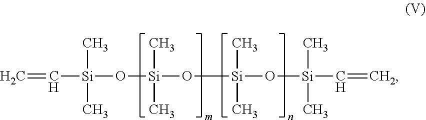

wherein m and n are as defined above in any of their embodiments.

A vinyl content of the one of more vinyl-substituted polysiloxanes can be in a range of from about 0.0010 mmol/g to about 5 mmol/g, about 0.005 mmol/g to about 0.1 mmol/g, or less than, equal to, or greater than about 0.0010 mmol/g, 0.0020, 0.0030, 0.0040, 0.0050, 0.0060, 0.0070, 0.0080, 0.0090, 0.0100, 0.0200, 0.0300, 0.0400, 0.0500, 0.0600, 0.0700, 0.0800, 0.0900, 0.1000, 0.2000, 0.3000, 0.4000, 0.5000, 0.6000, 0.7000, 0.8000, 0.9000, 1, 1.5, 2, 2.5, 3, 3.5, 4, 4.5, or about 5 mmol/g, as reported by the manufacturer.

A viscosity of the one or more vinyl-substituted polysiloxanes can independently be in a range of from about 100 mPa-s to about 500,000 mPa-s at 25° C., about 200 mPa-s to about 300,000 mPa-s, or less than, equal to, or greater than about 100 mPa-s, 150 mPa-s, 200 mPa-s, 250 mPa-s, 300 mPa-s, 350 mPa-s, 400 mPa-s, 450 mPa-s, 500 mPa-s, 250,000 mPa-s, 300,000 mPa-s, 400,000 mPa-s, 500,000 mPa-s at 25° C. As discussed below, the viscosity of the vinyl polysiloxane can affect the uniformity of the closed or open foamed cells formed in a resulting cured composition.

The second part of the two-part composition of the present disclosure includes a hydrosilyl-substituted polysiloxane. The two-part composition can include one or more hydrosilyl-substituted polysiloxanes. In some embodiments, the hydrosilyl-substituted polysiloxane is a blend of hydrosilyl-substituted polysiloxanes that differ in structure, molecular weight, mole percent of repeating units, or hydrogen content. In some embodiments, the hydrosilyl-substituted polysiloxane comprises one or more hydrosilyl-substituted polysiloxane homopolymers, hydrosilyl-substituted polysiloxane copolymers, or combinations thereof. The hydrosilyl-substituted polysiloxane forms part of a cross-linked network in a cured product prepared by combining the first part and the second part of the two-part composition and can also react with any -OH groups to form hydrogen gas which can foam the cured product.

The hydrosilyl-substituted polysiloxane component can be in a range of from about 0.5 wt % to about 30 wt % of the second part, about 5 wt % to about 20 wt %, or less than, equal to, or greater than about 0.5 wt %, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or about 30 wt %, based on the total weight of the second part of the two-part composition.

In some embodiments, the hydrosilyl-substituted polysiloxane in the two-part composition comprises first divalent units independently represented by formula X as defined above in any of its embodiments. In some embodiments, the hydrosilyl-substituted polysiloxane includes at least one of a terminal hydrogen bonded to silicon or a divalent unit represented by formula XII:

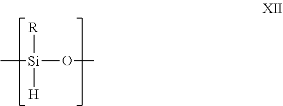

wherein each R is independently as described above in any of its embodiments in connection with formula X and XI.

The hydrosilyl-substituted polysiloxanes can be prepared by known synthetic methods, and many are commercially available (for example, from Dow Corning Corporation, Midland, Mich., or from Gelest, Inc., Morrisville, Pa. (see, for example, the polysiloxanes described in Silicon Compounds: Silanes and Silicones, Second Edition, edited by B. Arkles and G. Larson, Gelest, Inc. (2008)).

In some embodiments, the hydrosilyl-substituted polysiloxane comprises a hydrosilyl-substituted polysiloxane represented by formula Formula VI:

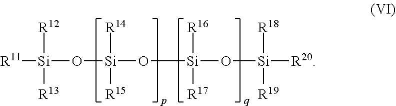

In Formula VI, R¹¹, R¹², R¹³, R¹⁴, R¹⁵, R¹⁶, R¹⁷, R¹⁸, R¹⁹, and R²⁰ are independently —H, —OH, or substituted or unsubstituted (C₁-C₂₀)hydrocarbyl in any of the embodiments described above for R, and at least one of R¹¹, R¹⁴, R¹⁵, and R²⁰ is —H. In some embodiments, R¹¹, R¹², R¹³, R¹⁴, R¹⁵, R¹⁶, R¹⁷, R¹⁸, R¹⁹, and R²⁰ of the polysiloxane according to Formula VI are independently —H, —OH, or substituted or unsubstituted (C₁-C₂₀)alkyl, (C₁-C₂₀)alkenyl, (C₁-C₂₀)alkynyl, (C₁-C₂₀)cycloalkyl, (C₁-C₂₀)aryl, (C₁-C₂₀)alkoxyl, and (C₁-C₂₀)haloalkyl, and at least one of. In some embodiments, R¹¹, R¹², R¹³, R¹⁴, R¹⁵, R¹⁶, R¹⁷, R¹⁸, R¹⁹, and R²⁰ of the polysiloxane according to Formula VI are independently substituted or unsubstituted (C₁-C₂₀)alkyl, (C₁-C₂₀)cycloalkyl, (C₁-C₂₀)aryl, or (C₁-C₂₀)haloalkyl, wherein at least one of R¹¹, R¹⁴, R¹⁵, or R²⁰ is —H.

In Formula VI, p and q are in random or block orientation. The units p and q represent the number of each repeating unit in the polysiloxane. Alternatively or additionally, the units p and q represent the mol % of each repeating unit in the polysiloxane. The unit p can be any positive integer and the unit q can be any positive integer or zero. In some embodiments, q is in a range from 0 to 1000 (in some embodiments, 0 to 500, 0 to 400, 0 to 300, 0 to 200, 0 to 150, 0 to 100, or 0 to 20), and p is in a range from 1 to 1000 (in some embodiments, 1 to 500, 1 to 400, 1 to 300, 1 to 200, 1 to 150, 5 to 100, or 20 to 80). In some embodiments, q is 0. In some embodiments, p is in a range from 20 to 80, 30 to 60, or 30 to 50. In some embodiments of formula VI, at least 40 percent, and in some embodiments at least 50 percent, of the R¹¹, R¹², R¹³, R¹⁴, R¹⁵, R¹⁶, R¹⁷, R¹⁸, R¹⁹, and R²⁰ groups are phenyl, methyl, or combinations thereof. For example, at least 60 percent, at least 70 percent, at least 80 percent, at least 90 percent, at least 95 percent, at least 98 percent, or at least 99 percent of the R¹¹, R¹², R¹³, R¹⁴, R¹⁵, R¹⁶, R¹⁷, R¹⁸, R¹⁹, and R²⁰ groups can be phenyl, methyl, or combinations thereof. In some embodiments, at least 40 percent, and in some embodiments at least 50 percent, of the R¹¹, R¹², R¹³, R¹⁴, R¹⁵, R¹⁶, R¹⁷, R¹⁸, R¹⁹, and R²⁰ groups are methyl. For example, at least 60 percent, at least 70 percent, at least 80 percent, at least 90 percent, at least 95 percent, at least 98 percent, or at least 99 percent of the R¹¹, R¹², R¹³, R¹⁴, R¹⁵, R¹⁶, R¹⁷, R¹⁸, R¹⁹, and R²⁰ groups can be methyl. In some embodiments, each of the R¹¹, R¹², R¹³, R¹⁴, R¹⁵, R¹⁶, R¹⁷, R¹⁸, R¹⁹, and R²⁰ is methyl. Although formula VI is shown as a block copolymer, it should be understood that the units can be randomly positioned in the copolymer. Thus, polyorganosiloxanes useful for practicing the present disclosure also include random copolymers.

In some embodiments, the hydrosilyl-substituted polysiloxane comprises at least one of a hydrosilyl-substituted polysiloxane represented by Formula VII or a hydrosilyl-substituted polysiloxane represented by Formula VIII:

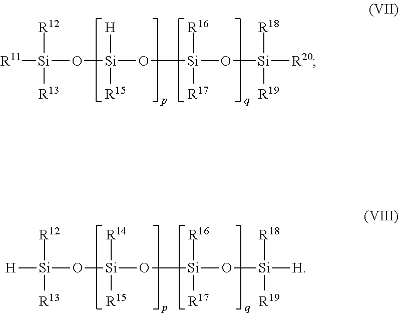

wherein R¹¹, R¹², R¹³, R¹⁴, R¹⁵, R¹⁶, R¹⁷, R¹⁸, R¹⁹, and R²⁰, p, and q are as defined above in any of their embodiments.

In some embodiments, the hydrosilyl-substituted polysiloxane comprises a hydrosilyl-substituted polysiloxane represented by Formula IX:

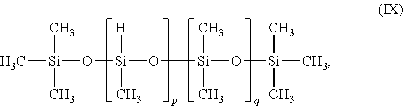

wherein p and q are as defined above in any of their embodiments.

In some embodiments, the hydrosilyl-substituted polysiloxane comprises a hydrosilyl-substituted polysiloxane represented by Formula X:

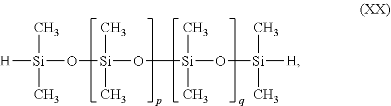

wherein p and q are as defined above in any of their embodiments.

A hydrogen content of the one of more hydrosilyl-substituted polysiloxanes can be in a range of from about 0.0010 mmol/g to about 5 mmol/g, about 0.005 mmol/g to about 0.1 mmol/g, or less than, equal to, or greater than about 0.0010 mmol/g, 0.0020, 0.0030, 0.0040, 0.0050, 0.0060, 0.0070, 0.0080, 0.0090, 0.0100, 0.0200, 0.0300, 0.0400, 0.0500, 0.0600, 0.0700, 0.0800, 0.0900, 0.1000, 0.2000, 0.3000, 0.4000, 0.5000, 0.6000, 0.7000, 0.8000, 0.9000, 1, 1.5, 2, 2.5, 3, 3.5, 4, 4.5, or about 5 mmol/g. A hydrosilyl equivalency, reported as the mole fraction of DH units (e.g., CH₃(H)SiO) over the mole fraction of the DH units combined with D units (e.g., (CH₃)₂SiO) can be determined using ²⁹Si NMR. In some embodiments, each hydrosilyl-substituted polysiloxane has a hydrosilyl equivalency, reported as the mole fraction of DH units, of at least 20 mol-% DH. In some embodiments, each hydrosilyl-substituted polysiloxane has a hydrosilyl equivalency, reported as the mole fraction of DH units, of up to 100 mol-% DH, calculated using this method.

The first part and the second part include first polymeric microspheres and second polymeric microspheres, respectively. The first polymeric microspheres and second polymeric microspheres can be the same or different from each other, and each can include one or more types of polymeric microspheres. In some embodiments, the first and second polymeric microspheres are identical in microsphere composition and inorganic filler coating composition. In some embodiments, the first and second polymeric microspheres are different in at least one of microsphere composition or inorganic filler coating composition. In some embodiments, the first and/or second polymeric microspheres can include a blend of polymeric microspheres that differ in at least one of microsphere composition or inorganic filler coating composition. The polymeric microspheres are useful, for example, for reducing foam density and helping the foaming process.

The polymeric microspheres can be present in the two-part composition (e.g., the first part, the second part, both the first part and the second part, or the curable composition resulting from combining the first part and the second part) in any suitable amount. In some embodiments, the polymeric microspheres are present in the two-part composition (e.g., the first part, the second part, or the curable composition resulting from combining the first part and the second part) in a range of from about 0.05 wt % to about 10 wt % of the curable composition, about 0.30 wt % to about 3 wt %, or less than, equal to, or greater than about 0.05 wt %, 0.10, 0.15, 0.20, 0.25, 0.30, 0.35, 0.40, 0.45, 0.50, 0.55, 0.60, 0.65, 0.70, 0.75, 0.80, 0.85, 0.90, 0.95, 1, 1.05, 1.10, 1.15, 1.20, 1.25, 1.30, 1.35, 1.40, 1.45, 1.50, 1.55, 1.60, 1.65, 1.70, 1.75, 1.80, 1.85, 1.90, 1.95, 2, 2.05, 2.10, 2.15, 2.20, 2.25, 2.30, 2.35, 2.40, 2.45, 2.50, 2.55, 2.60, 2.65, 2.70, 2.75, 2.80, 2.85, 2.90, 2.95, 3, 3.05, 3.10, 3.15, 3.20, 3.25, 3.30, 3.35, 3.40, 3.45, 3.50, 3.55, 3.60, 3.65, 3.70, 3.75, 3.80, 3.85, 3.90, 3.95, 4, 4.05, 4.10, 4.15, 4.20, 4.25, 4.30, 4.35, 4.40, 4.45, 4.50, 4.55, 4.60, 4.65, 4.70, 4.75, 4.80, 4.85, 4.90, 4.95, 5, 5.05, 5.10, 5.15, 5.20, 5.25, 5.30, 5.35, 5.40, 5.45, 5.50, 5.55, 5.60, 5.65, 5.70, 5.75, 5.80, 5.85, 5.90, 5.95, 6, 6.05, 6.10, 6.15, 6.20, 6.25, 6.30, 6.35, 6.40, 6.45, 6.50, 6.55, 6.60, 6.65, 6.70, 6.75, 6.80, 6.85, 6.90, 6.95, 7, 7.05, 7.10, 7.15, 7.20, 7.25, 7.30, 7.35, 7.40, 7.45, 7.50, 7.55, 7.60, 7.65, 7.70, 7.75, 7.80, 7.85, 7.90, 7.95, 8, 8.05, 8.10, 8.15, 8.20, 8.25, 8.30, 8.35, 8.40, 8.45, 8.50, 8.55, 8.60, 8.65, 8.70, 8.75, 8.80, 8.85, 8.90, 8.95, 9, 9.05, 9.10, 9.15, 9.20, 9.25, 9.30, 9.35, 9.40, 9.45, 9.50, 9.55, 9.60, 9.65, 9.70, 9.75, 9.80, 9.85, 9.90, 9.95, or about 10 wt %, based on the total weight of the two-part composition (e.g, the first part, the second part, both the first part and the second part, or the curable composition resulting from combining the first part and the second part).

The polymeric microspheres can include a gaseous interior (e.g., air, or any suitable gas, such as an inert gas like nitrogen or argon). The polymeric microspheres can include a polymer shell, which can be formed from any one or more suitable polymers, such as acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA, such as nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a fluoropolymer, a polytetrafluoroethylene polymer (PTFE), a polyethylene terephthalate polymer (PET), a polycyclohexylene dimethylene terephthalate polymer (PCT), a poly(cyclohexylenedimethylene terephthalate-co-ethylene glycol) (PCTG), a Tritan™ copolyester, a polycarbonate polymer (PC), poly(1,4-cyclohexylidene cyclohexane-1,4-dicarboxylate) (PCCD), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), a styrene-acrylonitrile polymer (SAN), and a combination thereof. The polymer shell can include a polymer formed from one or more independently selected substituted or unsubstituted ethylenically-unsaturated (C₁-C₅₀)hydrocarbons. For example, the polymer shell can include poly(acrylonitrile-co-vinylidene chloride-co-methyl methacrylate).

Suitable polymeric microspheres include pre-expanded or unexpanded microspheres. Unexpanded organic hollow microsphere fillers are available, for example, from Akzo Nobel under the trade designation EXPANCEL. The EXPANCEL microspheres include a polymer shell encapsulating an essentially liquid gas such as liquid isobutane. The unexpanded microspheres expand when the temperature is raised, for example, during curing so that the curable composition expands and foams during curing. EXPANCEL unexpanded microspheres are available in different types characterized, for example, by different onset temperatures. The onset temperature, which can be selected depending on, for example, the curing temperature of the curable composition, can be in a range of from about 80° C. to 130° C.

Unexpanded microspheres are sometimes also referred to as expandable organic microballoons which are also available, for example, from Lehmann & Voss, Hamburg, Germany under the trade designation MICROPEARL.

Pre-expanded polymeric microspheres are commercially available, for example, from Chase Corporation of Westwood, Mass., under the trade designation DUALITE. The pre-expanded polymeric microspheres may include a polymer shell comprising, for example, at least one of an acrylonitrile/acrylate copolymer or a vinylidenechloride/acrylonitrile copolymer. The shell encapsulates a core including, for example, one or more essentially gaseous hydrocarbons.

A median diameter size (D₅₀) of at least one of the first or second polymeric microspheres can be in a range of from about 1 μm to about 500 μm, about 20 μm to about 250 μm, or less than, equal to, or greater than about 1 μm, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, or about 500 μm.

The polymeric microspheres are at least partially coated with an inorganic filler. Suitable inorganic fillers include calcium carbonate (Ca(CO₃)₂), aluminum trihydroxide (ATH), and magnesium hydroxide (Mg(OH)₂). The inorganic filler at least partially coated on the second polymer microsphere can advantageously be a pH-neutral inorganic filler or an inorganic filler that typically has low moisture absorption and limited solubility in second part to cause the instability of the second part, such as ATH filler and magnesium hydroxide. The fire-retardant characteristics of these fillers may also provide better handling during operation. The inorganic filler on the first and second polymeric microspheres, respectively, can be the same or different. In some embodiments, the inorganic filler coating on the first and second polymer microsphere comprises at least one of ATH or Mg(OH)₂. In some embodiments, the inorganic filler coating on the second polymer microsphere is one of ATH or Mg(OH)₂, and the inorganic filler coating on the first polymer microsphere is calcium carbonate. In some embodiments, the first polymer microsphere can be blend of polymer microspheres having different inorganic filler coatings. In some embodiments, the inorganic filler coating on the first and second polymeric microspheres comprises ATH. In some embodiments, the inorganic filler coating on the second polymeric microspheres comprises ATH, and the inorganic filler coating on the first polymeric microspheres comprises calcium carbonate.

As shown in the examples below, in a cured sealant made from a composition including ATH coated polymer bubbles in the second part, the compression set of the sealant remained relatively constant over storage time of the two-part composition, but with Ca(CO₃)₂-coated polymer microspheres in the second part, the compression set increased dramatically over storage time of the two-part composition. In some embodiments, the sealant has no more than 50% increase comparing the compression set of the fresh sealant to the sealant after 30 days room temperature storage of the two-part composition, with compression set evaluated at the same condition: 24 hours at 85° C. at 50% compression. Storage of the two-part composition refers to storage of the first part separated from the second part. Compression set is measured after the first and second parts are combined and cured at room temperature for 24 hours.

The first part of the two-part composition of the present disclosure includes a hydrosilylation catalyst. The hydrosilylation catalyst can function to catalyze the formation of a network during curing. The catalyst can be any of those known to catalyze the addition of silicon-bonded hydrogen atoms (hydride groups) to silicon-bonded vinyl radicals (that is, hydrosilylation catalysts). In some embodiments, the hydrosilylation catalyst includes a transition metal catalyst. The transition metal catalyst is typically a platinum group metal catalyst: ruthenium, rhodium, palladium, osmium, iridium, and platinum. Platinum group metal-containing catalysts can be any of those that are compatible with polysiloxanes. Examples of suitable platinum group metal containing catalysts include platinic chloride, salts of platinum, chloroplatinic acid, and various complexes. In examples where the hydrosilylation catalyst includes a platinum complex, the catalyst can be added in an amount to provide from about 1 ppm to about 1000 ppm platinum to the two-part composition, in some embodiments, to provide about 10 ppm to about 250 ppm, or less than, equal to, or greater than about 1 ppm, 10, 15, 20, 30, 40, 50, 60, 70, 80, 90, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650 ,660, 670, 680, 690, 700, 710, 720, 730, 740, 750, 760, 770, 780, 790, 800, 810, 820, 830, 840, 850, 860, 870, 880, 890, 900, 910, 920, 930, 940, 950 ,960, 970, 980, 990, or about 1000 ppm platinum to the two-part composition (e.g., the first part or the curable composition resulting from combining the first part and the second part). In some embodiments, the hydrosilylation catalyst is chloroplatinic acid, complexed with a siloxane such as tetramethylvinylcyclosiloxane (i.e. 1,3,5,7-tetramethyl-1,3,5,7-tetravinylcyclosiloxane) or 1,3-divinyl-1,1,3,3-tetramethyldisiloxane, bis(acetylacetonato)platinum(ii), cis-diamminedichloroplatinum(ii), di-μ-chloro-bis[chloro(cyclohexene)platinum(ii)], cis-dichlorobis(triphenylphosphane)platinum(ii), dichloro(cycloocta-1.5-diene)platinum(ii), dihydrogen hexachloroplatinate(iv) hydrate, dihydrogen hexachloroplatinate(iv), platinum(0) divinyltetramethylsiloxane complex, tetrakis(triphenylphosphane)platinum(0), dihydrogen hexachloroplatinate(iv) solution, or a combination thereof. In some embodiments, the hydrosilylation catalyst is a platinum(0)-1,3-divinyl-1,1,3,3-tetramethyldisiloxane complex (i.e., Karstedt's catalyst).

The first part of the two-part composition of the present disclosure includes expandable graphite comprising moisture. The expandable graphite can be present in the first part in a range of from about 0.05 wt % to about 30 wt %, about 2 wt % to about 20 wt % of the curable composition, about 5 wt % to about 20 wt %, about 2 wt % to about 15 wt % or less than, equal to, or greater than about, 0.05 wt %, 0.5, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or about 30.5 wt %, based on the total weight of the first part of the composition. The expandable graphite can include a plurality of flakes and can act as a flame retardant in the resulting cured product. The plurality of graphite flakes can have a mesh size independently in a range of from about 20 to about 350, about 50 to about 200, or less than, equal to, or greater than about 20, 30, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, or about 350 as measured by Standard USA Test Sieves conforming to ASTM E-11-09.

The second part of the two-part composition of the present disclosure can be free of expandable graphite comprising moisture, or the expandable graphite can be present in the second part at a level of up to about 15 wt %, 10 wt %, 8 wt %, 5 wt %, 3 wt %, 2 wt %, 1 wt %, 0.5 wt %, 0.05 wt % or less, based on the total weight of the second part of the composition.

The graphite flakes can include moisture (e.g., water) that is pre-adsorbed or pre-blended thereon. As described further herein, having graphite flakes that include moisture typically and surprisingly can help to create substantially uniform sized foamed cells in the cured composition when foam is formed from the hydrogen gas resulting from the reaction of the hydrosilyl-substituted polysiloxane and moisture from graphite and additionally with any water or alcohol added to the reaction. Individual graphite flakes can include moisture in a range of from about 0.05 wt % to about 5 wt %, about 0.1 wt % to about 2 wt %, or less than, equal to, or greater than about 0.05, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, 4.1, 4.2, 4.3, 4.4, 4.5, 4.6, 4.7, 4.8, 4.9, or about 5 wt %, based on the weight of the flake. Additional water can be added to the two-part composition (e.g, the first part or the curable composition resulting from combining the first part and the second part) to augment the moisture provided by the graphite flakes.

To control the rate of polymerization of the curable composition, the two-part composition (e.g, the first part, the second part, or the curable composition resulting from combining the first part and the second part) can include a reaction retardant or reaction inhibitor. The reaction retardant can be in a range of from about 0.01 wt % to about 5 wt %, about 0.05 wt % to about 2 wt %, or less than equal to, or greater than about 0.01 wt %, 0.05, 0.1, 0.15, 0.2, 0.25, 0.3, 0.35, 0.4, 0.45, 0.5, 0.55, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.65, 4.7, 4.75, 4.8, 4.85, 4.9, 4.95, or about 5 wt %, based on the total weight of the two-part composition, (e.g, the first part, the second part, or the curable composition resulting from combining the first part and the second part).

The reaction retardant/inhibitor can be chosen from many suitable compounds that are capable of controlling the rate of polymerization. Examples of suitable reaction retardants include 1,3,5,7-tetramethyl-1,3,5,7-tetravinyl-cyclotetrasiloxane, 1,3-divinyl tetramethyl disiloxane, 2-methyl-3-butyn-2-ol, 2-phenyl-3-butyn-2-ol, 3,5-dimethyl-1-hexyn-3-ol, 1-ethynyl-1-cyclohexanol, 1,5-hexadiene, 1,6-heptadiene; 3,5-dimethyl-1-hexen-lyne, 3-ethyl-3-buten-1-yne, 3-phenyl-3-buten-1-yne; 1,3-divinyltetramethyldisiloxane, 1,3,5,7-tetravinyltetramethyl cyclotetrasiloxane, 1,3-divinyl-1,3-diphenyldimethyldisiloxane, methyltris (3-methyl-1-butyn-3-oxy) silane, and combinations thereof.

In some embodiments, the two-part composition (e.g, the first part, the second part, or the curable composition resulting from combining the first part and the second part) includes an inorganic filler other than the inorganic filler used to at least partially coat the polymeric microspheres. Inorganic filler can be useful, for example, to increase flame retardancy, to add strength (e.g., tensile strength or % elongation at break), to increase viscosity, to reduce manufacturing costs, or to adjust density in a cured product formed from the two-part composition (e.g., after combining the first part and the second part). The inorganic filler can be present in the two-part composition in a range of from about 2 wt % to about 30 wt %, about 5 wt % to about 15 wt %, or less than, equal to, or greater than about 2 wt %, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, 20, 20.5, 21, 21.5, 22, 22.5, 23, 23.5, 24, 24.5, 25, 25.5, 26, 26.5, 27, 27.5, 28, 28.5, 29, 29.5, or about 30 wt %, based on the total weight of the two-part composition, (e.g, the first part, the second part, or the curable composition resulting from combining the first part and the second part).

Suitable inorganic fillers include fibrous and particulate fillers. The inorganic filler can include glass fibers, aluminum silicate (mullite), synthetic calcium silicate, zirconium silicate, fused silica, crystalline silica graphite, natural silica sand, boron powders (e.g., boron-nitride powder or boron-silicate powders, oxides (e.g., TiO₂, aluminum oxide (particulate or fibrous), magnesium oxide, or zinc oxide), calcium sulfate (e.g., as its anhydride, dehydrate, or trihydrate), calcium carbonate (e.g., chalk, limestone, marble, or synthetic precipitated calcium carbonates), talc (e.g., fibrous, modular, needle shaped, or lamellar talc), wollastonite, surface-treated wollastonite, ceramic spheres (e . g . , hollow and solid glass spheres, silicate spheres, cenospheres, or aluminosilicate (armospheres)), kaolin (e.g., hard kaolin, soft kaolin, or calcined kaolin), single crystal fibers or “whiskers” (e.g., of silicon carbide, alumina, boron carbide, iron, nickel, or copper), fibers, including continuous and chopped fibers, (e.g., asbestos or carbon fibers) and short inorganic fibers such as those derived from blends including at least one of aluminum silicates, aluminum oxides, magnesium oxides, or calcium sulfate hemihydrate), sulfides (e.g., molybdenum sulfide or zinc sulfide), barium compounds (e.g., barium titanate, barium ferrite, barium sulfate, or heavy spar), metals (e.g., bronze, zinc, copper and nickel metal mesh or metal plate), flaked fillers (e.g., glass flakes, flaked silicon carbide, aluminum diboride, aluminum flakes, or steel flakes), mica, clay, feldspar, flue dust, fillite, quartz, quartzite, perlite, Tripoli, diatomaceous earth, carbon black, and combinations of any of these fillers. The inorganic filler can surface treated with silanes, siloxanes, or a combination of silanes and siloxanes to improved adhesion and dispersion. In some embodiments, the inorganic filler is a silica filler. The silica filler can be any suitable silica filler, such that the sealant composition can be used as described herein. In some embodiments, the inorganic filler is fumed silica.

In some embodiments, the two-part composition (e.g, the first part, the second part, or the curable composition resulting from combining the first part and the second part) includes an organic filler, for example, in any of the amounts described above for inorganic fillers. Suitable organic fillers include wood flour obtained by pulverizing wood, fibrous products (e.g., kenaf, cellulose, cotton, sisal, jute, flax, starch, corn flour, lignin, ramie, rattan, agave, bamboo, hemp, ground nut shells, corn, coconut (coir), or rice grain husks), polytetrafluoroethylene, reinforcing organic fibrous fillers formed from organic polymers capable of forming fibers (e.g., poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, or poly(vinyl alcohol), and combinations of any one of these fillers.

In some embodiments, the two-part composition (e.g, the first part, the second part, or the curable composition resulting from combining the first part and the second part) includes additional water. The water can be present in a range of from about 0.01 wt % to about 5 wt % of the two-part composition, about 0.01wt % to about 1 wt %, or less than, equal to, or greater than about 0.01 wt %, 0.05, 0.1, 0.15, 0.2, 0.25, 0.3, 0.35, 0.4, 0.45, 0.5, 0.55, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.65, 4.7, 4.75, 4.8, 4.85, 4.9, 4.95, or about 5 wt %, based on the total weight of the first part, the second part, or the curable composition resulting from combining the first part and the second part.

In some embodiments, the two-part composition (e.g, the first part, the second part, or the curable composition resulting from combining the first part and the second part) includes an alcohol having at least one hydroxyl group. The alcohol can be present in a range of from about 0.01 wt % to about 5 wt % of the curable composition, about 0.01wt % to about 1 wt %, or less than, equal to, or greater than about 0.01 wt %, 0.05, 0.1, 0.15, 0.2, 0.25, 0.3, 0.35, 0.4, 0.45, 0.5, 0.55, 0.65, 0.7, 0.75, 0.8, 0.85, 0.9, 0.95, 1, 1.05, 1.1, 1.15, 1.2, 1.25, 1.3, 1.35, 1.4, 1.45, 1.5, 1.55, 1.65, 1.7, 1.75, 1.8, 1.85, 1.9, 1.95, 2, 2.05, 2.1, 2.15, 2.2, 2.25, 2.3, 2.35, 2.4, 2.45, 2.5, 2.55, 2.65, 2.7, 2.75, 2.8, 2.85, 2.9, 2.95, 3, 3.05, 3.1, 3.15, 3.2, 3.25, 3.3, 3.35, 3.4, 3.45, 3.5, 3.55, 3.65, 3.7, 3.75, 3.8, 3.85, 3.9, 3.95, 4, 4.05, 4.1, 4.15, 4.2, 4.25, 4.3, 4.35, 4.4, 4.45, 4.5, 4.55, 4.65, 4.7, 4.75, 4.8, 4.85, 4.9, 4.95, or about 5 wt %, based on the total weight of the first part, the second part, or the curable composition resulting from combining the first part and the second part.

The alcohol having at least one hydroxyl group can include any suitable alcohol. For example, the alcohol can include a monofunctional alcohol, a polyfunctional alcohol, or a combination thereof. Examples of suitable alcohols include propanol, glycol, or a combination thereof. The alcohol can be useful, for example, to help create uniform foamed cells in the cured product or serve as a cross-linker for the polysiloxanes. In some embodiments, at least one of the alcohol having at least one hydroxyl group or water can increase the level of foaming in a cured product formed from the two-part composition (e.g., after combining the first part and the second part) by allowing for a reaction between the water and/or alcohol and the hydrosilyl-substituted polysiloxane to create hydrogen gas.

In some embodiments of the two-part composition, the first part includes the vinyl-substituted polysiloxane, the hydrosilylation catalyst, the expandable graphite, the first polymeric microspheres, and at least one of the reaction retardant, the inorganic filler, the alcohol having at least one hydroxyl group, or water. In some embodiments, the second part includes the vinyl-substituted polysiloxane, the hydrosilyl-substituted polysiloxane, the second polymeric microspheres, and the inorganic filler component.

The first part and the second part can be combined at any suitable volume ratio. For example, the first part and the second part can be combined at a volume ratio in a range of from about 5:100 to about 100:1, about 10:100 to about 50:1, or less than, equal to, or greater than about 5:100, 20:100, 30:100, 40:100, 50:100. 60:100, 70:100, 80:100, 90:100, 1:1, 10:1, 20:1, 30:1, 40:1, 50:1, 60:1, 70:1, 80:1, 90:1, or about 100:1.

After the first part and the second part are combined to form the curable composition, the curable composition can be spun at any suitable speed to facilitate adequate mixing. For example, the curable composition can be spun at a low speed by hand. Alternatively, the curable composition can be spun at a high speed using a machine. For example, the mixture can be spun at a speed of about 1000 rpm to about 3000 rpm, about 1500 rpm to about 2500 rpm, or less than, equal to, or greater than about 1000 rpm, 1100, 1200, 1300, 1400, 1500, 1600, 1700, 1800, 1900, 2000, 2100, 2200, 2300, 2400, 2500, 2600, 2700, 2800, 2900, or about 3000 rpm.

The first part and the second part can be located in any suitable system or kit for containing, mixing, and dispensing the first part and the second part. The system can be suited for large-scale industrial applications or small-scale applications. Either system can include first and second chambers for holding the respective first part and second part. The chambers can be sized for any application and formed from plastic, metal, or any other suitable material. A dispenser can be adapted to receive the first part and the second part and dispense a mixture of the first part and the second part on a substrate. The dispenser can function to facilitate mixing of the first part and the second part, or a mixing chamber can be disposed upstream of the dispenser and in fluid communication with the first chamber and the second chamber. The mixing chamber can be adapted to rotate in order to facilitate mixing, or the mixing chamber can include a number of baffles to induce rotation of the first part and the second part.

To facilitate movement of the first part and the second part, the system can include elements such as one or more plunger or one or more pumps. The one or more plungers can be useful for systems that are handheld. In these embodiments, a user can push one or two plungers, between at least a first and a second position, to force the first part and the second part through the system. If there is one plunger, then the first part and the second part can be dispensed at equal volumes or at a predetermined volume ratio.

Pumps can be useful in industrial applications where large volumes or a continuous supply of the first part and the second part are dispensed. These systems can include one or more pumps that are in fluid communication with the first and second chambers. The one or more pumps can be located downstream of the first and second chambers but upstream of the mixing chamber. In embodiments of the system in which there are two pumps in fluid communication with respective first and second chambers, the pumps can be adapted or controlled to pump an equal volume of the first part and the second part or to pump different quantities of each part according to a predetermined volume ratio.

Following mixing, the curable composition can be dispensed, by hand or through a system, on to a substrate and cured thereon. Curing can be accomplished at room temperature although the rate of reaction can be controlled by altering the temperature. For example, the rate of reaction can be slowed by lowering the temperature below room temperature, or the rate of reaction can be increased by raising the temperature above room temperature. In some embodiments, the composition can be cured at a temperature in a range of from about 0° C. to about 100° C., about 15° C. to about 40° C., about 15° C. to about 30° C. or less than, equal to, or greater than about 0° C., 0.5, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 20, 20.5, 21, 21.5, 22, 22.5, 23, 23.5, 24, 24.5, 25, 25.5, 26, 26.5, 27, 27.5, 28, 28.5, 29, 29.5, 30, 30.5, 31, 31.5, 32, 32.5, 33, 33.5, 34, 34.5, 35, 35.5, 36, 36.5, 37, 37.5, 38, 38.5, 39, 39.5, 40, 40.5, 41.5, 42, 42.5, 43, 43.5, 44, 44.5, 45, 45.5, 46, 46.5, 47, 47.5, 48, 48.5, 49, 49.5, 50, 50.5, 51.5, 52, 52.5, 53, 53.5, 54, 54.5, 55, 55.5, 56, 56.5, 57, 57.5, 58, 58.5, 59, 59.5, 60, 60.5, 61.5, 62, 62.5, 63, 63.5, 64, 64.5, 65, 65.5, 66, 66.5, 67, 67.5, 68, 68.5, 69, 69.5, 70, 70.5, 71.5, 72, 72.5, 73, 73.5, 74, 74.5, 75, 75.5, 76, 76.5, 77, 77.5, 78, 78.5, 79, 79.5, 80, 80.5, 81.5, 82, 82.5, 83, 83.5, 84, 84.5, 85, 85.5, 86, 86.5, 87, 87.5, 88, 88.5, 89, 89.5, 90, 90.5, 91.5, 92, 92.5, 93, 93.5, 94, 94.5, 95, 95.5, 96, 96.5, 97, 97.5, 98, 98.5, 99, 99.5, or about 100° C. Curing can occur over any suitable amount of time. For example, curing may occur over an amount of time ranging from about 0.5 minutes to about 24 hours, about 0.5 minutes to about 10 hours, or less than, equal to, or greater than about 0.5 minutes, 1 minute, 5 minutes, 10 minutes, 15 minutes, 20 minutes, 25 minutes, 30 minutes, 35 minutes, 40 minutes, 45 minutes, 50 minutes, 55 minutes, 1 hour, 2 hours, 3 hours, 4 hours, 5 hours, 6 hours, 7 hours, 8 hours, 9 hours, 10 hours, 11 hours, 12 hours, 13 hours, 14 hours, 15 hours, 16 hours, 17 hours, 18 hours, 19 hours, 20 hours, 21 hours, 22 hours, 23 hours, or about 24 hours.

The cured product of the two-part composition is formed from curing any of the curable compositions described herein (e.g., prepared by combining the first part and the second part). Cured product includes expandable graphite and polymeric microspheres dispersed therein and typically further includes a plurality of foamed closed cells or open cells. In some embodiments, the foamed cells have a uniform size (e.g., largest diameter D₁) and are uniformly distributed throughout the cured composition. A median diameter D₅₀ of the foamed cells can be in a range of from about 1 μm to about 5000 μm, about 20 μm to about 2000 μm, or less than, equal to, or greater than about 1 μm, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 1000, 1500, 2000, 2500, 3000, 3500, 4000, 4500 or about 5000 μm. In further embodiments, a diameter of about 98% of foamed cells (D₉₈) can be in a range of from about 1 μm to about 5000 μm, about 20 μm to about 2000 μm, or less than, equal to, or greater than about 1 μm, 5, 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280, 285, 290, 295, 300, 305, 310, 315, 320, 325, 330, 335, 340, 345, 350, 355, 360, 365, 370, 375, 380, 385, 390, 395, 400, 405, 410, 415, 420, 425, 430, 435, 440, 445, 450, 455, 460, 465, 470, 475, 480, 485, 490, 495, 500, 1000, 1500, 2000, 2500, 3000, 3500, 4000, 4500 or about 5000 μm.

The presence of the expandable graphite comprising moisture in the curable composition can promote uniformity in the size and distribution of foamed cells. The expandable graphite includes water, which may react with the hydrosilyl-substituted polysiloxane during curing to foam the cured product. The presence of polymeric microspheres, which typically decreases the density of the curable composition, can also contribute to the uniform size and distribution of foamed cells. Another factor that can contribute to the uniformity of foamed cells is the viscosity of the curable composition. The viscosity can depend on, for example, the vinyl-substituted polysiloxane, the polymeric microspheres, and the inorganic filler amount and type added into the curable composition. During curing, if the viscosity of the curable composition is too low, the bubbles formed will simply escape, thus preventing formation of foamed cells. However, if the viscosity is too high, the bubbles formed cannot penetrate through the entire volume of the curable composition. This leads to a non-uniform distribution of foamed cells. For further information regarding the uniformity of foamed cells, see copending application number PCT/2018/100644, filed Aug. 15, 2018.

The uniformity of foamed cells provides many benefits in the cured product of the curable composition. For example, in some embodiments, the uniformity of foamed cells can help to ensure that each surface of the cured product is substantially smooth. This is because the cured product will be free of non-uniform agglomerations of foamed cells that would lead to protrusions along a surface of the cured product. Smooth surfaces in the cured product can help to create a tight seal between two substrates, which, in some embodiments, may be a substantially water proof seal. The uniformity of foamed cells can also help to ensure that the cured product has a desirable density. The density of the cured product can be in a range of from about 0.200 g/cm³ to about 0.800 g/cm³, about 0.300 g/cm³ to about 0.700 g/cm³, or less than, equal to, or greater than about 0.200 g/cm³, 0.250, 0.300, 0.350, 0.400, 0.450, 0.500, 0.550, 0.600, 0.650, 0.700, 0.750, or about 0.800 g/cm³. A low density in a cured product can result in weight savings and can contribute to the cured product's ability to be water proof, to be flame retardant, and/or have a low compression set.

Compression set measures the ability of a material to return to its original thickness after prolonged compressive stresses at a given temperature. As a material is compressed over time, it might lose its ability to return to its original thickness. This loss of resiliency may reduce the capability of an elastomeric gasket, seal, or cushioning pad to perform over a long period of time. The resulting permanent set that material may take over time may cause a leak; or in the case of a shock isolation pad, the ability to protect an accidentally dropped unit may be compromised. As is understood, the lower the compression set, the better the material resists permanent deformation. The cured product can have a compression set measured at about 85° C. for 24 hours at a compression ratio of 50% that is in a range of from about 0% to about 60%, about 0% to about 40%, or less than equal to, or greater than about 0%, 5, 10, 15, 20, 25, 30, 35, 40, 45, 50, 55, or about 60%. As discussed further herein, the cured product can be used a seal; therefore, low compression sets in the cured product are desirable.

Another desirable property of the cured product is that at least a portion of it can be substantially free of a tacky feel. This can be desirable because debris such as dirt or other particulate materials are less likely to stick to cured product and create a gap between the cured product and a substrate. Additionally, the lack of a tacky feel can make it easier to disengage the cured product from a substrate.

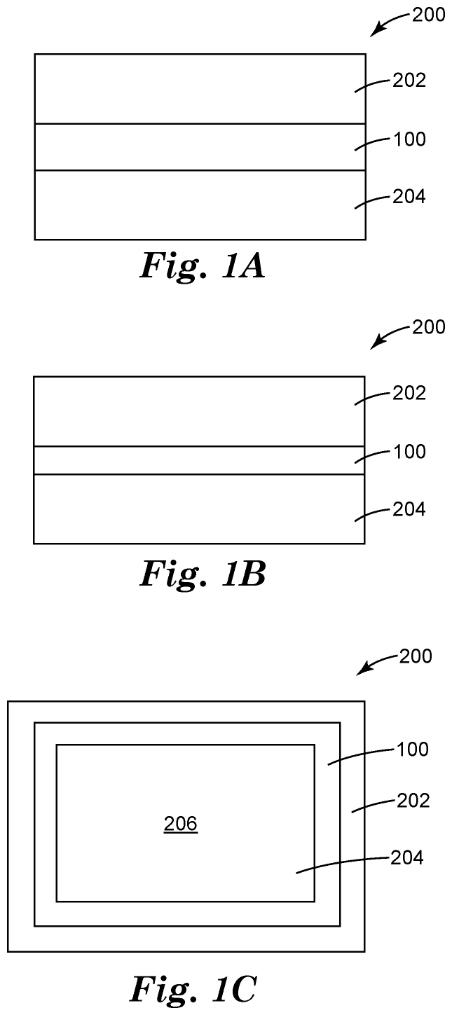

FIG. 1A is a sectional view of assembly 200 in a resting state. FIG. 1B is a sectional view of assembly 200 in a compressed state. FIG. 1C is a top view of assembly 200. As shown in FIGS. 1A and 1B, assembly 200 includes cured product 100, first substrate 202, and second substrate 204. Cured product 100 is in contact with at least one of first substrate 202 or second substrate 204. As shown, cured product 100 is in continuous contact with first substrate 202 and second substrate 204. That is, assembly 200 is free of a gap between the cured product and the first substrate and second substrate. In the resting state cured product 100, is free of compression or is at least less compressed than it is in the compressed state as shown in FIG. 1B. As described further herein cured product 100 can be brought to the compressed state by applying pressure to first substrate 202 and second substrate 204 with a clamp; however, in some embodiments, the weight of either first substrate 202 or second substrate 204 will be enough to compress cured product 100. Compression of cured product 100 can enhance the ability of cured product 100 to effectively create a seal.

Cured product 100 can be adhered to one of first substrate 202 or second substrate 204 while being free of adhesion with the other substrate. The adhesion to one of first substrate 202 or second substrate 204 can be a function of the curable composition being deposited on one of first substrate 202 or second substrate 204 and being cured thereon. Typically, the curable composition at least partially adheres to the surface it is cured on. To avoid adhesion to both first substrate 202 and second substrate 204, depositing the curable composition between first substrate 202 and second substrate 204 when it is cured can be avoided. The ability of cured product 100 to be free of adhesion with one of first substrate 202 or second substrate 204 can allow for the substrates to be removably secured to each other. First substrate 202 and second substrate 204 can be removably secured through a device such as a clamp.

First substrate 202 and second substrate 204 can form a box that encloses a void. This is shown in FIG. 1C. FIG. 1C shows first substrate 202 having cured product 100 adhered thereon. Cured product 100 circumscribes void 206. To enclose void 206, second substrate 204 can be placed into contact with cured product 100.

Cured product 100 can be substantially flame retardant. This can be due to, for example, the inclusion of the expandable graphite component, the polymeric microspheres having a flame-retardant inorganic filler, as well as the other components. The flame retardancy of cured product 100 can be determined by at least one of a UL 94 having a V2, V1, and a V0 rating.

Additionally, cured product 100 can be substantially water proof. The water proof characteristics of cured product 100 can be determined by International Protection Marketing standard IP68. The water proof and flame retardant properties of cured product 100 can make cured product 100 well suited to be a sealer or gasket. The ability to foam cured product 100 can allow cured product to be classified as a foamed sealer. The sealer is well suited for use in many different systems or assemblies.

Referring again to FIG. 1C, the materials of first substrate 202 and second substrate 204 can also be flame-retardant and water proof. The water proof and flame-retardant properties of cured product make it well suited for applications in which assembly 200 encloses an electronic component. For example, assembly 200 can be a battery box in which a battery is placed in void 206. The flame-retardant properties of cured product 100 can help to protect a battery or other electronic component from external flames or help prevent spread of flames from the battery or other electronic component in the event of a fire caused by a failure. Additionally, the water proof properties of cured product 100 can help to protect the electronic component from unwanted exposure to moisture.

Assembly 200 can be used in conjunction with many other assemblies or machines. For example, assembly 200 can be a component of a vehicle. Examples of suitable vehicles can include an automobile. The automobile can be an electric automobile. Other vehicles include a train, an aerospace vehicle (e.g., airplane, helicopter, or space craft), or a water craft.

Assembly 200 can be formed according to any suitable method. For example, assembly 200 can be formed by contacting the curable composition with one of first substrate 202 or second substrate 204. Curable composition is cured thereon. The substrate that is free of cured composition 100 is then brought into contact with cured composition 100. To secure first substrate 202 and second substrate 204, pressure can be applied to each substrate to compress cured composition 100. A clamp or other suitable device can be used to apply a suitable amount of pressure.

### Some Embodiments of the Disclosure

In a first embodiment, the present disclosure provides a two-part composition comprising:
a first part comprising:
   a vinyl-substituted polysiloxane;
   a hydrosilylation catalyst;
   expandable graphite comprising moisture; and
   first polymeric microspheres having been at least partially coated with inorganic filler, and
a second part comprising:
   a second vinyl-substituted polysiloxane;
   a hydrosilyl-substituted polysiloxane; and
   second polymeric microspheres having been at least partially coated with flame-retardant inorganic filler.

In a second embodiment, the present disclosure provides the two-part composition of the first embodiments, wherein the first and second vinyl-substituted polysiloxanes are present a range of from about 20 wt % to about 90 wt %, based on the total weight of the two-part composition.

In a third embodiment, the present disclosure provides the two-part composition of the first or second embodiment, wherein at least one of the first or second vinyl-substituted polysiloxanes comprises a vinyl-substituted polysiloxane represented by Formula I:

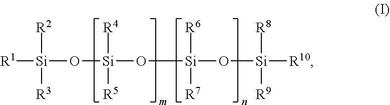

wherein
R¹, R², R³, R⁴, R⁵, R⁶, R⁷, R⁸, R⁹, and R¹⁰ are independently —H, —OH, or substituted or unsubstituted (C₁-C₂₀)hydrocarbyl;
at least one of R¹, R⁴, R⁵, and R¹⁰, comprises a vinyl group;
m is any positive integer;
n is zero or any positive integer; and
m and n are in random or block orientation. In a fourth embodiment, the present disclosure provides the two-part composition of any one of the first to third embodiments, wherein at least one of the first or second vinyl-substituted polysiloxanes comprises a vinyl-substituted polysiloxane represented by Formula II or Formula III:

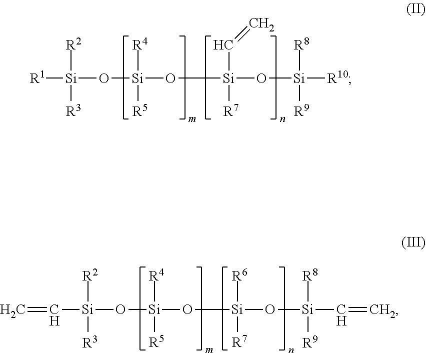

wherein
R¹, R², R³, R⁴, R⁵, R⁶, R⁷, R⁸, R⁹, and R¹⁰ are independently substituted or unsubstituted (C₁-C₂₀)alkyl, (C₁-C₂₀)cycloalkyl, (C₁-C₂₀)aryl, or (C₁-C₂₀)haloalkyl;
at least one of R¹, R⁴, R⁵, and R¹⁰, comprises a vinyl group;
m is any positive integer;
n is zero or any positive integer; and
m and n are in random or block orientation.

In a fifth embodiment, the present disclosure provides the two-part composition of the fourth embodiment, wherein each R¹, R², R³, R⁴, R⁵, R⁶, R⁷, R⁸, R⁹, and R¹⁰ is methyl.

In a sixth embodiment, the present disclosure provides the two-part composition of any one of the first to fifth embodiments, wherein at least one of the first or second vinyl-substituted polysiloxanes independently has a viscosity in a range of from about 100 mPa-s to about 500,000 mPa-sat 25° C.

In a seventh embodiment, the present disclosure provides the two-part composition of any one of the first to sixth embodiments, wherein at least one of the first or second vinyl-substituted polysiloxanes independently has a vinyl content in a range of from about 0.0010 mmol/g to about 5 mmol/g.

In an eighth embodiment, the present disclosure provides the two-part composition of any one of the first to seventh embodiments, wherein hydrosilyl-substituted polysiloxane is present in a range from about 0.5 wt % to about 20 wt %, based on the total weight of the second part.

In a ninth embodiment, the present disclosure provides the two-part composition of any one of the first to eighth embodiments, wherein the hydrosilyl-substituted polysiloxane comprises a hydrosilyl-substituted polysiloxane represented by Formula VI:

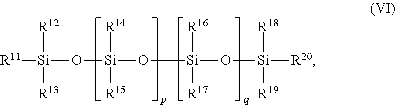

wherein R¹¹, R¹², R¹³, R¹⁴, R¹⁵, R¹⁶, R¹⁷, R¹⁸, R¹⁹, and R²⁰ are independently substituted or unsubstituted (C₁-C₂₀)hydrocarbyl;

at least one of R¹¹, R¹⁴, R¹⁵, and R²⁰, is —H;

p is any positive integer;

q is zero or any positive integer; and

p and q are in random or block orientation.

In a tenth embodiment, the present disclosure provides the two-part composition of any one of the first to ninth embodiments, wherein the hydrosilyl-substituted polysiloxane comprises hydrosilyl-substituted polysiloxane represented by Formula VII or Formula VIII:

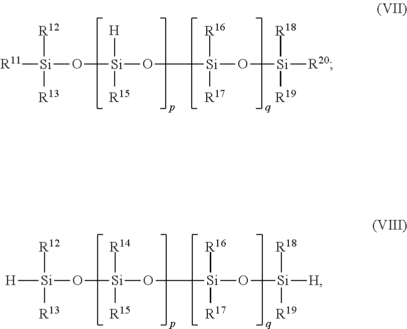

wherein
R¹¹, R¹², R¹³, R¹⁴, R¹⁵, R¹⁶, R¹⁷, R¹⁸, R¹⁹, and R²⁰ are independently substituted or unsubstituted (C₁-C₂₀)alkyl, (C₁-C₂₀)cycloalkyl, (C₁-C₂₀)aryl, or (C₁-C₂₀)haloalkyl;
at least one of R¹¹, R¹⁴, R¹⁵, and R²⁰, is —H;
p is any positive integer;
q is zero or any positive integer; and
p and q are in random or block orientation.

In an eleventh embodiment, the present disclosure provides the two-part composition of any one of the first to tenth embodiment, wherein each R¹¹, R¹², R¹³, R¹⁴, R¹⁵, R¹⁶, R¹⁷, R¹⁸, R¹⁹, and R²⁰ is methyl.

In a twelfth embodiment, the present disclosure provides the two-part composition of any one of the first to eleventh embodiments, wherein the hydrosilylation catalyst comprises platinum.

In a thirteenth embodiment, the present disclosure provides the two-part composition of any one of the first to twelfth embodiments, wherein the hydrosilylation catalyst provides from about 1 ppm to about 1000 ppm platinum, based on the weight of the first part.

In a fourteenth embodiment, the present disclosure provides the two-part composition of any one of the first to thirteenth embodiments, wherein the expandable graphite comprising moisture comprises a plurality of graphite flakes having a mesh size independently in a range of from about 20 mesh to about 350 mesh.

In a fifteenth embodiment, the present disclosure provides the two-part composition of any one of the first to fourteenth embodiments, wherein the expandable graphite comprising moisture comprises a plurality of graphite flakes independently having a moisture content in a range of from about 0.05 wt % to about 5 wt % per graphite flake.

In a sixteenth embodiment, the present disclosure provides the two-part composition of any one of the first to fifteenth embodiments, wherein the expandable graphite comprising moisture is present in a range of from about 0.05 wt % to about 30 wt %, based on the total weight of the first part.

In a seventeenth embodiment, the present disclosure provides the two-part composition of any one of the first to sixteenth embodiments, wherein the second part has less than 15 wt %, 10 wt %, 5 wt %, 3 wt %, 2 wt %, 1 wt %, or is free of the expandable graphite comprising moisture.

In an eighteenth embodiment, the present disclosure provides the two-part composition of any one of the first to seventeenth embodiments, further comprising water.

In a nineteenth embodiment, the present disclosure provides the two-part composition of any one of the first to eighteenth embodiments, wherein at least one of the first polymeric microspheres or second polymeric microspheres is present in a range of from about 0.05 wt % to about 10 wt %, based on the total weight of the two-part composition.

In a twentieth embodiment, the present disclosure provides the two-part composition of any one of the first to nineteenth embodiments, wherein at least one of the first polymeric microspheres or second polymeric microspheres comprises an acrylonitrile/acrylate copolymer, a vinylidenechloride/acrylonitrile copolymer, or a mixture thereof.

In a twenty-first embodiment, the present disclosure provides the two-part composition of any one of the first to twentieth embodiments, wherein at least one of the first polymeric microspheres or second polymeric microspheres has a median diameter (D₅₀) in a range of from about 1 μm to about 500 μm.

In a twenty-second embodiment, the present disclosure provides the two-part composition of any one of the first to twenty-first embodiments, wherein the first polymeric microspheres are the same as the second polymeric microspheres.

In a twenty-third embodiment, the present disclosure provides the two-part composition of any one of the first to twenty-second embodiments, wherein the first polymeric microspheres are different from the second polymeric microspheres.

In a twenty-fourth embodiment, the present disclosure provides the two-part composition of any one of the first to twenty-second embodiments, wherein the first polymeric microspheres and the second polymeric microspheres are each at the partially coated with the same inorganic filler.

In a twenty-fifth embodiment, the present disclosure provides the two-part composition of any one of the first to twenty-fourth embodiments, wherein the flame-retardant inorganic filler on the second polymeric microspheres is aluminum trihydroxide or magnesium hydroxide, in some embodiments, aluminum trihydroxide.

In a twenty-sixth embodiment, the present disclosure provides the two-part composition of any one of the first to twenty-fifth embodiments, wherein the inorganic filler on the first polymeric microspheres comprises at least one of aluminum trihydroxide, calcium carbonate, or magnesium hydroxide.

In a twenty-seventh embodiment, the present disclosure provides the two-part composition of any one of the first to twenty-sixth embodiments, further comprising a reaction inhibitor.

In a twenty-eighth embodiment, the present disclosure provides the two-part composition of any one of the first to twenty-seventh embodiments, further comprising an inorganic filler comprising at least one of a glass, a ceramic, a mineral, or a silica.

In a twenty-ninth embodiment, the present disclosure provides the two-part composition of the twenty-eighth embodiment, wherein the inorganic filler comprises silica

In a thirtieth embodiment, the present disclosure provides the two-part composition of the twenty-eighth or twenty-ninth embodiment, wherein the inorganic filler is present in a range of from about 2 wt % to about 30 wt %, based on the total weigh of the two-part composition.

In a thirty-first embodiment, the present disclosure provides the two-part composition of any one of the first to thirtieth embodiments, further comprising an alcohol having at least one hydroxyl group.

In a thirty-second embodiment, the present disclosure provides the two-part composition of the thirty-first embodiment, wherein the alcohol comprises at least one of propanol or ethylene glycol.

In a thirty-third embodiment, the present disclosure provides a cured product of the two-part composition of any one of the first to thirty-second embodiments.

In a thirty-fourth embodiment, the present disclosure provides a sealant comprising a cured product of the two-part composition of any one of the first to thirty-second embodiments.

In a thirty-fifth embodiment, the present disclosure provides the cured product of the thirty-third or thirty-fourth embodiment, having been cured at room temperature for 24 hours.

In a thirty-sixth embodiment, the present disclosure provides the cured product of any one of the thirty-third to thirty-fifth embodiments, prepared from a two-part composition stored for 30 days at room temperature, wherein a compression set of the cured product is not more than 50% higher than a compression set of the cured product prepared from the two-part composition freshly prepared, wherein compression set is measured after 24 hours at 50% compression at 85° C.

In a thirty-seventh embodiment, the present disclosure provides the cured product of any one of the thirty-third to thirty-sixth embodiments, wherein the cured product is substantially flame retardant.

In a thirty-eighth embodiment, the present disclosure provides the cured product of any one of the thirty-third to thirty-seventh embodiments, wherein the cured product is substantially flame retardant as determined by at least a UL 94 standard, V2, V1 and V0 rating.

In a thirty-ninth embodiment, the present disclosure provides an assembly comprising:

a first substrate;

a second substrate; and

the cured product of any one of the thirty-third to thirty-eighth embodiments in contact with the first substrate and the second substrate.

In a fortieth embodiment, the present disclosure provides the assembly of the thirty-ninth embodiment, wherein the first substrate and the second substrate are removably secured to each other.

In a forty-first embodiment, the present disclosure provides the assembly of the thirty-ninth or fortieth embodiment, wherein the first substrate and the second substrate enclose a void defined therebetween.

In a forty-second embodiment, the present disclosure provides the assembly of the forty-first embodiment, further comprising an electronic component located at least partially within the void.

In a forty-third embodiment, the present disclosure provides the assembly of the forty-second embodiment, wherein the electronic component is a battery.

In a forty-fourth embodiment, the present disclosure provides a vehicle comprising the assembly of any one of the thirty-ninth to forty-third embodiments.

In a forty-fifth embodiment, the present disclosure provides a method of making a curable composition, the method comprising combining the first part and the second part of the two-part composition of any one of the first to thirty-second embodiments.

In a forty-sixth embodiment, the present disclosure provides the two-part composition of any one of the first to thirty-second embodiments packaged in a system comprising a first chamber and a second chamber, wherein the first chamber comprises the first part, and wherein the second chamber comprises the second part.

In a forty-seventh embodiment, the present disclosure provides a system for carrying out the method of the forty-fifth embodiment, the system comprising a first chamber and a second chamber, wherein the first chamber comprises the first part, and wherein the second chamber comprises the second part.

In a forty-eighth embodiment, the present disclosure provides the two-part composition or system of the forty-sixth or forty-seventh embodiment, wherein the system further comprises at least one of a dispenser in fluid communication with the first chamber and the second chamber or a mixing tip in fluid communication with the first chamber and the second chamber.

In a forty-ninth embodiment, the present disclosure provides a method of forming the assembly of any one of the thirty-ninth to forty-third embodiments, the method comprising:

combining the first part and the second part to form a curable composition;

contacting the first substrate or the second substrate with the two-part composition; and allowing the curable composition to cure on the first substrate or the second substrate.

In a fiftieth embodiment, the present disclosure provides the method of the forty-ninth embodiment, wherein allowing the curable composition to cure is carried out at room temperature for 24 hours.

### EXAMPLES

Various embodiments of the present disclosure can be better understood by reference to the following Examples which are offered by way of illustration. The present disclosure is not limited to the Examples given herein.

TABLE 1
Materials

| Designation | Description | Source |
|---|---|---|
| 2827-186L | Divinyl tetramethyl disiloxane available under the | AB Specialty Silicones, |
| | trade designation ANDISIL 2827-186L | Waukegan, Ill., U.S. |
| ADT35 | Expandable graphite available under the designation | Shijiazhuang ADT |
| | ADT 35 | Carbonic Material Factory, |
| | | Shijiazhuang, China |
| ADT 1002 | Expandable graphite available under the designation | Shijiazhuang ADT |
| | ADT 1002 | Carbonic Material Factory |
| IMERSEAL 75 | Calcium carbonate, a premium, surface modified, | Fitz Chem LLC, Itasca, |
| | ultra-fine particle size, beneficiated, wet ground | Ill., United States |
| | marble available under the trade designation | |
| | IMERSEAL 75 | |
| E035-FR | Low density polymer expanded microspheres | Chase Corporation, |
| | available under the trade designation DUALITE | Westwood, Mass., United |
| | E035-FR | States |
| E065-135D | Low density polymer expanded microspheres | Chase Corporation |
| | available under the trade designation DUALITE | |
| | E065-135D | |
| MH 20 | Methyl hydrogen polysiloxane polymer available | AB Specialty Silicones |
| | under the trade designation ANDISIL MH 20 | |
| OH 40 | Silanol polymer functional fluid available under the | AB Specialty Silicones |
| | trade designation ANDISIL OH 40 | |
| Propanol or | Propanol or propylene glycol | Sigma Aldrich, St. Louis, |
| propylene glycol | | Mo., U.S. |
| Pt Catalyst | Platinum-divinyltetramethyldisiloxane complex; | Gelest, Morrisville, Pa., |
| | 3.0% Pt in vinyl terminated PDMS available under | U.S. |
| | the designation SIP6830.3 | |
| R8200 | Hydrophobic fumed silica available under the trade | Evonik Corporation, |
| | designation AEROSIL R 8200 | Allentown, Pa., U.S. |
| VS165K | Vinyl-terminated dimethylpolysilxane polymer | AB Specialty Silicones |
| | available under the trade designation ANDISIL VS | |
| | 165000 | |

### Test Methods

Compression Set: The method of ISO 1856:2000 was followed.
Specific Gravity: The method of ASTM D792-13 was followed using a Mettler Toledo balance density kit.
UL94-V0 Flame: Reference to the UL94-V0 standard with flame height 20-mm, bottom edge of the sample 10-mm into the flame and burn twice at 10 seconds each. A flame propagation height under 125-mm (5 inches) was considered a pass.

### Example 1 (EX1, Control)

Part A components of the formulations represented in Table 2 were mixed with a SpeedMixer™ DAC 400 FVZ high-speed shear mixer from Flack Tek, Inc. of Landrum, S.C. at 1500-2500 rpm for two to five minutes until the components mixed thoroughly. Part B components of the formulations represented in Table 2 were mixed with a SpeedMixer™ DAC 400 FVZ high-speed shear mixer from Flack Tek, Inc. of Landrum, S.C. at 1500-2500 rpm for two to five minutes until all the components mixed thoroughly. Parts A and B were filled in to 1:1 dual pack cartridge and mixed with a 1:1 volume 2K dispense gun from 3M with an 18-elements mixing nozzle and left for 24 hours at room temperature.

The sealant underwent compression set, specific gravity, and UL94-V0 testing, and the results are recorded in Table 7.

TABLE 2
Part A and Part B Compositions
(Weight Percent)

| Material | Part A | Part B |
|---|---|---|
| VS165K | 38.0 | 42.0 |
| R8200 | 7.0 | 9.0 |
| Pt Catalyst | 0.1 | 0.0 |
| 2827-186L | 1.0 | 0.0 |
| MH 20 | 0.0 | 4.0 |
| E065-135D | 0.5 | 0.5 |
| ADT 1002 | 4.0 | 0.0 |
| ADT35 | 4.0 | 0.0 |

### Example 2 (EX2)

Weight percentages of the materials identified in Table 3 for Part A and Part B in were each mixed in separate high-speed mixer cups (one for Part A and the other for Part B) at 2000 RPM for two to five minutes. Part A and Part B mixtures were then cooled to ambient temperature. Parts A and B were filled in to 1:1 dual pack cartridge and mixed with a 1:1 volume 2K dispense gun from 3M with 18 elements mixing nozzle and left for 24 hours at room temperature.

The sealant underwent compression set, specific gravity, and UL94-V0 testing, and the results are recorded in Table 7.

TABLE 3
Part A and Part B Compositions
(Weight Percent)

| Material | Part A | Part B |
|---|---|---|
| VS165K | 38.0 | 42.0 |
| R8200 | 7.0 | 9.0 |
| Pt Catalyst | 0.1 | 0.0 |
| 2827-186L | 1.0 | 0.0 |
| MH 20 | 0.0 | 4.0 |
| IMERSEAL 75 | 0.5 | 0.0 |
| E035-FR | 0.0 | 0.5 |
| E065-135D | 0.5 | 0.5 |
| ADT 1002 | 4.0 | 0.0 |
| ADT35 | 4.0 | 0.0 |

### Example 3 (EX3)

Weight percentages of the materials identified in Table 4 for Part A and Part B in were each mixed in separate high-speed mixer cups (one for Part A and the other for Part B) at 2000 RPM for two to five minutes. Part A and Part B mixtures were then cooled to ambient temperature. Parts A and B were filled in to 1:1 dual pack cartridge and mixed with a 1:1 volume 2K dispense gun from 3M with an 18-elements mixing nozzle and left for 24 hours at room temperature.

The sealant underwent compression set, specific gravity, and UL94-V0 testing, and the results are recorded in Table 7.

TABLE 4
Part A and Part B Compositions
(Weight Percent)

| Material | Part A | Part B |
|---|---|---|
| VS165K | 38.0 | 42.0 |
| R8200 | 7.0 | 9.0 |
| Pt Catalyst | 0.1 | 0.0 |
| 2827-186L | 1.0 | 0.0 |
| MH 20 | 0.0 | 6.0 |
| Propylene Glycol | 0.4 | 0.0 |
| Propanol | 0.4 | 0.0 |
| E035-FR | 0.5 | 0.5 |
| ADT 1002 | 4.0 | 0.0 |
| ADT35 | 4.0 | 0.0 |

### Example 4 (EX4)

Weight percentages of the materials identified in Table 5 for Part A and Part B in were each mixed in separate high-speed mixer cups (one for Part A and the other for Part B) at 2000 RPM for two to five minutes. Part A and Part B mixtures were then cooled to ambient temperature. Parts A and B were filled in to 1:1 dual pack cartridge and mixed with a 1:1 volume 2K dispense gun from 3M with an 18-elements mixing nozzle and left for 24 hours at room temperature.

The sealant underwent compression set, specific gravity, and UL94-V0 testing, and the results are recorded in Table 7.

TABLE 5
Part A and Part B Compositions
(Weight Percent)

| Material | Part A | Part B |
|---|---|---|
| VS165K | 38.0 | 42.0 |
| R8200 | 7.0 | 9.0 |
| Pt Catalyst | 0.1 | 0.0 |
| 2827-186L | 1.0 | 0.0 |
| MH 20 | 0.0 | 6.0 |
| Propylene Glycol | 0.4 | 0.0 |
| E035-FR | 0.5 | 0.5 |
| ADT 1002 | 4.0 | 0.0 |
| ADT35 | 4.0 | 0.0 |

### Example 5 (EX5)

Weight percentages of the materials identified in Table 6 for Part A and Part B in were each mixed in separate high-speed mixer cups (one for Part A and the other for Part B) at 2000 RPM for two to five minutes. Part A and Part B mixtures were then cooled to ambient temperature. Parts A and B were filled in to 1:1 dual pack cartridge and mixed with a 1:1 volume 2K dispense gun from 3M with an 18-elements mixing nozzle and left for 24 hours at room temperature.

The sealant underwent compression set, specific gravity, and UL94-V0 testing, and the results are recorded in Table 7.

TABLE 6
Part A and Part B Compositions
(Weight Percent)

| Material | Part A | Part B |
|---|---|---|
| VS165K | 38.0 | 42.0 |
| R8200 | 7.0 | 9.0 |
| Pt Catalyst | 0.1 | 0.0 |
| 2827-186L | 1.0 | 0.0 |
| MH 20 | 0.0 | 5.0 |
| Propylene Glycol | 0.4 | 0.0 |
| E035-FR | 0.5 | 0.5 |
| ADT 1002 | 4.0 | 0.0 |
| ADT35 | 4.0 | 0.0 |

Part A and Part B mixtures for each of Examples 1 to 5 were then aged for 15 or 30 days at room temperature. Parts A and B were filled in to 1:1 dual pack cartridge and mixed with a 1:1 volume 2K dispense gun from 3M with an 18-elements mixing nozzle and left for 24 hours at room temperature. The sealant underwent compression set and specific gravity testing, and the results are recorded in Table 7 under 15 and 30 days of aging for each of Examples 1 to 5.

TABLE 7
Compression Set and Density Test Results

| Days | Compression Set (%) | | | Specific Gravity | | | UL94-V0 |
|---|---|---|---|---|---|---|---|
| Aging | 0 | 15 | 30 | 0 | 15 | 30 | Flame |
| EX1 | 8.00 | 25.40 | 45.4 | 0.60 | 0.63 | 0.62 | Pass |
| EX2 | 5.80 | 8.02 | 7.50 | 0.71 | 0.76 | 0.79 | Pass |
| EX3 | 13.94 | 14.21 | 12.22 | 0.54 | 0.55 | 0.63 | Pass |
| EX4 | 14.80 | 12.06 | 12.89 | 0.49 | 0.55 | 0.60 | Pass |
| EX5 | 13.79 | 14.56 | 11.47 | 0.52 | 0.54 | 0.56 | Pass |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present disclosure. Thus, it should be understood that although the present disclosure has been specifically disclosed by specific embodiments and optional features, modification and variation of the concepts herein disclosed may be resorted to by those of ordinary skill in the art, and that such modifications and variations are considered to be within the scope of embodiments of the present disclosure.

1. A two-part composition comprising:
a first part comprising:
a vinyl-substituted polysiloxane;
a hydrosilylation catalyst;
expandable graphite comprising moisture; and
first polymeric microspheres having been at least partially coated with an inorganic filler, and
a second part comprising:
a second vinyl-substituted polysiloxane;
a hydrosilyl-substituted polysiloxane; and
second polymeric microspheres having been at least partially coated with aluminum trihydroxide.

2. The two-part composition of claim 1, wherein the first polymeric microspheres are the same as the second polymeric microspheres.

3. (canceled)

4. The two-part composition of claim 1, wherein the inorganic filler on the first polymeric microspheres comprises at least one of aluminum trihydroxide, calcium carbonate, or magnesium hydroxide.

5. The two-part composition of claim 1, wherein the hydrosilylation catalyst comprises platinum.

6. The two-part composition of claim 1, wherein the expandable graphite comprises a plurality of graphite flakes independently having a moisture content in a range of from about 0.05 wt % to about 5 wt % per graphite flake.

7. The two-part composition of claim 1, packaged in a system comprising a first chamber and a second chamber, wherein the first chamber comprises the first part, and wherein the second chamber comprises the second part.

8. The two-part composition of claim 1, wherein the vinyl-substituted polysiloxane comprises a vinyl-substituted polysiloxane represented by formula: 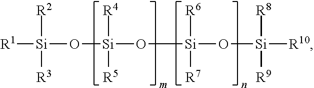
wherein
R¹, R², R³, R⁴, R⁵, R⁶, R⁷, R⁸, R⁹, and R¹⁰ are independently hydrogen, hydroxyl, or substituted or unsubstituted (C₁-C₂₀)hydrocarbyl, wherein at least one of R¹, R⁴, R⁵, or R¹⁰ comprises a vinyl group;
m is any positive integer;
n is zero or any positive integer; and
m and n are in random or block orientation.

9. The two-part composition of claim 1, wherein the vinyl-substituted polysiloxane comprises one or more vinyl-substituted polysiloxanes independently having viscosity in a range of from about 100 mPa-s to about 500,000 mPa-s at 25° C.

10. The two-part composition of claim 1, wherein the hydrosilyl-substituted polysiloxane comprises a hydrosilyl-substituted polysiloxane represented by formula: 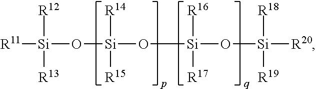
wherein R¹¹, R¹², R¹³, R¹⁴, R¹⁵, R¹⁶, R¹⁷, R¹⁸, R¹⁹, and R²⁰ are independently substituted or unsubstituted (C₁-C₂₀)hydrocarbyl, and at least one of R¹¹, R¹⁴, R¹⁵, and R²⁰, is —H;
p is any positive integer;
q is zero or any positive integer; and
p and q are in random or block orientation.

11. The two-part composition of claim 1, further comprising at least one of an inorganic filler or an alcohol having at least one hydroxyl group.

12. A sealant comprising a cured product of the two-part composition of claim 1.

13. The sealant of claim 12 prepared from a two-part composition stored for 30 days at room temperature, wherein a compression set of the sealant is not more than 50% higher than a compression set of the sealant prepared from the two-part composition freshly prepared, wherein compression set is measured after 24 hours at 50% compression at 85° C.

14. An assembly comprising:
a first substrate;
a second substrate; and
a cured product of the two-part composition of claim 1 in contact with the first substrate and the second substrate.

15. The assembly of claim 14, wherein the first substrate and the second substrate enclose a void defined therebetween, further comprising an electronic component located at least partially within the void.

16. The assembly of claim 15, wherein the electronic component is a battery.

17. The two-part composition of claim 1, further comprising an inorganic filler comprising at least one of a glass, a ceramic, a mineral, or silica.

18. The two-part composition of claim 1, wherein the first polymeric microspheres are different from the second polymeric microspheres.

19. The two-part composition of claim 1, wherein the expandable graphite comprising moisture is present in a range from about 0.05 percent by weight to about thirty percent by weight, based on the total weight of the first part.

20. The two-part composition of claim 1, wherein at least one of the first polymeric microspheres or the second polymeric microspheres is present in a range from about 0.05 percent by weight to about ten percent by weight, based on the total weight of the two-part composition.

21. The two-part composition of claim 1, wherein the hydrosilyl-substituted polysiloxane is present in a range from about 0.5 percent by weight to about twenty percent by weight, based on the total weight of the second part.
